(19) United States
(12) Patent Application Publication
(10) Pub. No.: US 2026/0106091 A1
(43) Pub. Date: Apr. 16, 2026

(54) ENERGY-STORAGE CARRYING MATERIAL AND PREPARATION METHOD THEREOF, STRUCTURAL ELECTRODE, AND PREPARATION METHOD AND USE THEREOF

(71) Applicants: Northeastern University, Shenyang City, (CN); Donghua University, Shanghai (CN)

(72) Inventors: Wenjing SUN, Shenyang City (CN); Qiantong TANG, Shanghai (CN); Xiating FENG, Shenyang City (CN)

(21) Appl. No.: 19/037,817

(22) Filed: Jan. 27, 2025

(30) Foreign Application Priority Data
Oct. 15, 2024 (CN) 202411433375.7

(51) Int. Cl. H01G 11/86; B28B 1/24; H01G 11/24

(52) U.S. Cl. CPC H01G 11/86; H01G 11/24; B28B 1/24

(57) ABSTRACT

Provided are an energy-storage carrying material, a preparation method of the energy-storage carrying material, a structural electrode, and a preparation method of the structural electrode. The energy-storage carrying material includes a matrix and an electrically-conductive network structure distributed inside the matrix, where the matrix is a hydration product of an industrial by-product; and the electrically-conductive network structure includes an electrically-conductive material and a magnetically-modified soil.

### CROSS REFERENCE TO RELATED APPLICATION

This patent application claims the benefit and priority of Chinese Patent Application No. 2024114333757 filed with the China National Intellectual Property Administration on Oct. 15, 2024, the disclosure of which is incorporated by reference herein in its entirety as part of the present application.

### TECHNICAL FIELD

The present disclosure belongs to the technical field of resource recycling, and specifically relates to an energy-storage carrying material and a preparation method thereof, a structural electrode, and a preparation method and use thereof.

### BACKGROUND

Traditional power supply modes, such as thermal power generation, long-range power transmission, and distributed generation systems, have problems in environmental protection, resource depletion, stability, or land supply to varying degrees, making it difficult to achieve the sustainable development of the traditional power supply modes. Therefore, researchers have advocated the development of green energy buildings and energy self-sufficient buildings. Currently, some researchers have proposed the following concept: Buildings themselves can be transformed into electrical energy-storage devices. Photovoltaic panels can be arranged on the roofs of buildings. The electrical energy converted by the photovoltaic panels is directly stored in the buildings, and the stored electrical energy can be used to meet the daily electricity demand or serve as an emergency backup energy source. In this way, the energy self-sufficiency of the buildings is achieved.

The construction of green energy buildings and energy self-sufficient buildings inevitably requires the use of structural electrodes. The conventional electrodes are typically made of metals or metal oxides, and often do not have a carrying capacity. Some researchers try to use cements as structural electrodes. Although some properties of these structural electrodes meet the corresponding requirements, these structural electrodes have low cycling retention rates, which cannot meet the requirements of green energy buildings and energy self-sufficient buildings.

### SUMMARY

An object of the present disclosure is to provide an energy-storage carrying material, a preparation method of the energy-storage carrying material, a structural electrode, and a preparation method and use of the structural electrode. The structural electrode provided by the present disclosure has a carrying capacity and an energy-storage capacity, and exhibits a high cycling retention rate.

To achieve the above object, the present disclosure provides the following technical solutions:

The present disclosure provides an energy-storage carrying material, including a matrix and an electrically-conductive network structure distributed inside the matrix, where the matrix is a hydration product of an industrial by-product; and the electrically-conductive network structure includes an electrically-conductive material and a magnetically-modified soil.

In some embodiments, a mass ratio of the matrix to the electrically-conductive network structure is in a range of 35-100:0.01-5; and a mass ratio of the electrically-conductive material to the magnetically-modified soil is in a range of 0.01-5:20-50.

The present disclosure also provides a method for preparing the energy-storage carrying material described above, including the following steps:
mixing the industrial by-product, the magnetically-modified soil, the electrically-conductive material, and an alkali activator to obtain a mixed slurry, wherein the industrial by-product has a pozzolanic activity and is able to undergo a pozzolanic reaction in an environment with a pH of not less than 10; and
subjecting the mixed slurry to compacting and curing in sequence in an external magnetic field to obtain the energy-storage carrying material.

In some embodiments, the magnetically-modified soil is a magnetically-modified clay; and the magnetically-modified clay is prepared by the following steps:

mixing an activated clay with water to obtain a clay suspension, adding Fe₃O₄ magnetic nanoparticles to the clay suspension, and stirring and mixing, such that clay particles in the clay suspension adsorb the Fe₃O₄ magnetic nanoparticles, wherein the Fe₃O₄ magnetic nanoparticles are synthesized through chemical co-precipitation of Fe³⁺ and Fe²⁺ salts.

The present disclosure also provides a structural electrode, including an electrode body and a current collector partially embedded in the electrode body, where the electrode body is the energy-storage carrying material described above or the energy-storage carrying material prepared by the method described above.

In some embodiments, a connecting part of the electrode body at two sides of the current collector has a same length as the electrode body, and a width of 0.3 cm to 0.7 cm.

The present disclosure also provides a method for preparing the structural electrode described above, including the following steps:
mixing the industrial by-product, the magnetically-modified soil, the electrically-conductive material, and an alkali activator to obtain a mixed slurry; and
injecting the mixed slurry into a mold, placing the current collector in the mixed slurry while the mixed slurry is still in a flowing state, and placing the mold in an external magnetic field and conducting compaction and curing in sequence to obtain the structural electrode.

In some embodiments, the curing includes a mould curing and a demound curing in sequence; and
the mould curing is conducted at a temperature of 18° C. to 22° C. and a humidity of 95% to 98% for 24 h to 48 h.

In some embodiments, the demound curing is conducted by soaking in a soaking solution for curing; a concentration of the soaking solution is 1 M to 6 M; the soaking solution includes one or more selected from the group consisting of a NaCl solution, a KCl solution, a Na₂SO₄ solution, a K₂SO₄ solution, a NaOH solution, and a KOH solution; and the demound curing is conducted at ambient temperature.

The present disclosure also provides use of the structural electrode described above or the structural electrode prepared by the method described above in a field of energy development and utilization.

The present disclosure provides an energy-storage carrying material. The energy-storage carrying material of the present disclosure has both a prominent carrying capacity and a prominent energy-storage capacity, a cycling retention rate of not less than 93% under 5,000 cycles, and a high compressive strength.

The present disclosure also provides a method for preparing the energy-storage carrying material described above. In the present disclosure, an industrial by-product, a magnetically-modified soil, and an electrically-conductive material are adopted as main raw materials. The industrial by-product has a pozzolanic activity, and a hydration product resulting from the industrial by-product can form a strong three-dimensional network structure to provide a carrying capacity for the material. The magnetically-modified soil can be arranged directionally under an action of an external magnetic field to form a continuous electrically-conductive network, which provides a path for the electrically-conductive material to form a complete electrically-conductive network. In addition, a surface of the magnetically-modified soil has negative charges, such that the magnetically-modified soil is easily dispersed in water and can bind to cations, which facilitates the conduction of ions or electrons and improves the electrochemical performance. The negative charges on the surface of the magnetically-modified soil can also increase the dispersion of the electrically-conductive material and overcome the characteristic of easy agglomeration of the electrically-conductive material. The evenly dispersed electrically-conductive material makes it possible to form increased effective electrically-conductive paths and enhance the electrical conductivity of the material.

The present disclosure also provides a structural electrode. The structural electrode of the present disclosure has both a carrying capacity and an energy-storage capacity, a cycling retention rate of not less than 93% under 5,000 cycles, a high compressive strength, excellent stability, and superior compatibility with buildings. The structural electrode of the present disclosure adopts the electric double layer capacitor principle to store electricity, and exhibits prominent stability and durability. In addition, the structural electrode makes it possible to avoid the hidden dangers of leakage and fire of the traditional pseudocapacitors and the disposal problems caused by the scrapping of chemical batteries, and is eco-friendly and sustainable.

The present disclosure also provides a method for preparing the structural electrode described above. In the present disclosure, the structural electrode is fabricated with an industrial by-product, a magnetically-modified soil, and an electrically-conductive material as main raw materials through processes such as mixing, curing, and soaking, which avoids a high-energy-density firing process. The industrial by-product has a pozzolanic activity, and a hydration product resulting from the industrial by-product can form a strong three-dimensional network structure to provide a carrying capacity for the structural electrode. The magnetically-modified soil can be arranged directionally under an action of an external magnetic field to form a continuous electrically-conductive network, which provides a path for the electrically-conductive material to form a complete electrically-conductive network and is favorable for electrons to be evenly transferred to all corners of an electrode through a current collector. In addition, a surface of the magnetically-modified soil has negative charges, such that the magnetically-modified soil is easily dispersed in water and can bind to cations, which facilitates the conduction of ions or electrons and improves the electrochemical performance. The negative charges on the surface of the magnetically-modified soil can also increase the dispersion of the electrically-conductive material and overcome the characteristic of easy agglomeration of the electrically-conductive material. The evenly dispersed electrically-conductive material makes it possible to form increased effective electrically-conductive paths and enhance the electrical conductivity of the structural electrode, specifically as shown in FIG. 2A and FIG. 2B.

The method of the present disclosure involves simple steps, low process energy consumption, and low raw material costs, achieves the recycling and high-value utilization of industrial solid wastes, and creates significant economic benefits, environmental benefits, and social benefits.

The present disclosure also provides use of the structural electrode described above or the structural electrode prepared by the method described above in a field of energy development and utilization. The structural electrode of the present disclosure can be used in the field of energy development and utilization, and specifically can be used for energy utilization in the construction field or energy utilization in the civil engineering field, such as foundations or partition walls for buildings. Therefore, the structural electrode can support the energy self-sufficiency of buildings, can promote the development of green energy buildings and energy self-sufficient buildings, and has a high market promotion value.

### BRIEF DESCRIPTION OF THE DRAWINGS

To describe the technical solutions in the embodiments of the present disclosure or in the prior art clearly, the accompanying drawings required for the embodiments are briefly described below. Apparently, the accompanying drawings in the following description show merely some embodiments of the present disclosure, and those skilled in the art may still derive other accompanying drawings from these accompanying drawings without creative efforts.

FIG. 1A shows process flows for the preparation of the magnetically-modified soil in an embodiment of the present disclosure;

FIG. 1B shows process flows for the preparation of the structural electrode in an embodiment of the present disclosure;

FIG. 2A shows a schematic diagram of the structural electrode provided in an embodiment of the present disclosure;

FIG. 2B shows a schematic working diagram of the structural electrode provided in an embodiment of the present disclosure;

FIG. 3 shows electrochemical impedance spectroscopy (EIS) curves of the structural electrodes in Example 1 and Comparative Examples 1 to 3;

FIG. 4 shows compressive strengths of the structural electrodes in Example 1 and Comparative Examples 1 to 3;

FIG. 5 shows surface capacitances of the structural electrodes in Example 1 and Comparative Examples 1 to 3; and

FIG. 6 shows cycling retention rates of the structural electrodes in Example 1 and Comparative Examples 1 to 3.

### DETAILED DESCRIPTION OF THE EMBODIMENTS

The present disclosure provides an energy-storage carrying material, including a matrix and an electrically-conductive network structure distributed inside the matrix. The matrix is a hydration product of an industrial by-product. The electrically-conductive network structure includes an electrically-conductive material and a magnetically-modified soil.

In the present disclosure, in some embodiments, a mass ratio of the matrix to the electrically-conductive network structure is in a range of (35-100):(0.01-5), and preferably 35:0.01, 35:0.1, 35:1, 35:5, 95:0.01, 95:0.1, 95:1, 95:5, 100:0.01, 100:0.1, 100:1, or 100:5.

In the present disclosure, in some embodiments, a mass ratio of the electrically-conductive material to the magnetically-modified soil is in a range of (0.01-5):(20-50), and preferably 0.01:20, 0.01:30, 0.01:40, 0.01:50, 0.1:20, 0.1:30, 0.1:40, 0.1:50, 1:20, 1:30, 1:40, 1:50, 3:20, 3:40, 5:20, or 5:50.

The present disclosure also provides a method for preparing the energy-storage carrying material described above, including the following steps:
mixing the industrial by-product, the magnetically-modified soil, the electrically-conductive material, and an alkali activator to obtain a mixed slurry, wherein the industrial by-product has a pozzolanic activity and is able to undergo a pozzolanic reaction in an environment with a pH of not less than 10; and
compacting and curing the mixed slurry in sequence in an external magnetic field to obtain the energy-storage carrying material.

In the present disclosure, the industrial by-product, the magnetically-modified soil, the electrically-conductive material, and an alkali activator are mixed to obtain a mixed slurry. In the present disclosure, in some embodiments, the industrial by-product includes one or more selected from the group consisting of a silicon-aluminum-based by-product, a calcium sulfate-based by-product, and an alkaline by-product. In some embodiments, the silicon-aluminum-based by-product includes one or more selected from the group consisting of a mineral slag, a steel slag, and a fly ash. In some embodiments, the calcium sulfate-based by-product includes one or more selected from the group consisting of phosphogypsum, fluorogypsum, and citric acid gypsum. In some embodiments, the alkaline by-product includes one or more selected from the group consisting of a carbide slag and an alkali residue.

The industrial by-product often includes metal impurities and metal oxides. These metal impurities and metal oxides not only improve the electrical conductivity of a cementing material, but also form an electrically-conductive network during alkali excitation, thereby improving the overall electrical conductivity of the material. In addition, the industrial by-product is produced with a main product and does not cause the additional carbon emission. Thus, the energy-storage carrying material of the present disclosure has characteristics such as low economic cost, low environmental cost, and high-valued solid waste utilization.

In the present disclosure, in some embodiments, the industrial by-product has a particle size of less than or equal to 0.15 μm, and preferably 0.15 μm, 0.13 μm, 0.11 μm, 0.10 μm, 0.08 μm, 0.05 μm, 0.03 μm, or 0.01 μm.

In the present disclosure, in some embodiments, the industrial by-product is pretreated before use. In some embodiments, the pretreating is conducted as follows: the industrial by-product is dried, ground, and sieved in sequence. In some embodiments, the drying is oven-drying. In some embodiments, the drying is conducted at a temperature of 40° C. to 105° C. In some embodiments, the drying is conducted until a mass change within 24 h is not more than 0.5%.

In the present disclosure, in some embodiments, when the industrial by-product is a silicon-aluminum-based by-product, the drying is conducted at a temperature of 80° C. to 105° C., and preferably 80° C., 85° C., 90° C., 95° C., 100° C., or 105° C. In some embodiments, when the industrial by-product is a calcium sulfate-based by-product, the drying is conducted at a temperature of 45° C. to 60° C., and preferably 45° C., 50° C., 55° C., or 60° C. In some embodiments, when the industrial by-product is an alkaline by-product, the drying is conducted at a temperature of 40° C. to 60° C., and preferably 40° C., 45° C., 50° C., 55° C., or 60° C.

In the present disclosure, in some embodiments, the grinding is conducted for 10 min to 15 min, and preferably 10 min, 12 min, 14 min, or 15 min.

In the present disclosure, in some embodiments, a particle size for the sieving is a target particle size of the industrial by-product, and a sieve residue is controlled at less than 5%.

In the present disclosure, in some embodiments, the magnetically-modified soil is a magnetically-modified clay. In some embodiments, the magnetically-modified clay is prepared by the following method: an activated clay is mixed with water (which is denoted as second mixing) to obtain a clay suspension, Fe₃O₄ magnetic nanoparticles are added to the clay suspension, and stirred and mixed (which is denoted as third mixing), such that clay particles in the clay suspension adsorb the Fe₃O₄ magnetic nanoparticles.

In the present disclosure, in some embodiments, the water is deionized water. in some embodiments, the clay is a natural clay mineral, with a liquid limit of 27% to 40% and a plastic limit of 20% to 27%. In some embodiments, the clay can be one or more selected from the group consisting of a muddy clay, a silty clay, and kaolin.

In the clay, high-valence atoms usually undergo isomorphous substitution with low-valence atoms (an octahedral atom Al or Mg is substituted with Li). The isomorphic substitution results in negative charges on a surface of the clay, and these negative charges are compensated by interlayer cations (such as Li, Na, and Ca), which are beneficial for modification of the clay.

In the present disclosure, in some embodiments, the clay is dried and then ground before use. In some embodiments, a device for the drying is an oven. In some embodiments, the drying is conducted at 105° C. for not less than 24 h, and preferably 24 h, 30 h, 36 h, or 48 h. In some embodiments, a device for the grinding is a ball mill. In some embodiments, the grinding is conducted at a rotational speed of 16 rpm to 20 rpm, and preferably 16 rpm, 17 rpm, 18 rpm, 19 rpm, or 20 rpm. In some embodiments, the grinding is conducted for 15 min to 30 min, and preferably 15 min, 18 min, 24 min, 27 min, or 30 min.

In the present disclosure, in some embodiments, the activation is an activation with hydrochloric acid. In some embodiments, the activation with hydrochloric acid is as follows: the clay and the hydrochloric acid are mixed (which is denoted as mixing B), and then subjected to activation and standing. In some embodiments, a mass ratio of the clay to the hydrochloric acid is in a range of 1:(30-50), and preferably 1:30, 1:35, 1:40, 1:45, or 1:50. In some embodiments, a concentration of the hydrochloric acid is 3.5 M to 4.5 M, and preferably 3.5 M, 4.0 M, or 4.5 M. In some embodiments, the mixing B is conducted under stirring. In some embodiments, the standing is conducted for 1 h.

In the present disclosure, in some embodiments, a resulting system produced after the standing is subjected to supernatant removal, water-washing and centrifugation, and drying in sequence. In some embodiments, the water-washing and centrifugation is conducted 2 times to 5 times, and preferably 2 times, 3 times, 4 times, or 5 times, until a resulting washing supernatant has a pH of 6.1 to 6.9. In some embodiments, water adopted for the water-washing and centrifugation is deionized water.

In the present disclosure, in some embodiments, a device for the drying is an oven. In some embodiments, the drying is conducted at a temperature of 50° C. to 60° C., and preferably 50° C., 53° C., 56° C., or 60° C. In some embodiments, the drying is conducted for 24 h.

In the present disclosure, in some embodiments, a mass ratio of the activated clay to the water is in a range of 1:(5-10), and preferably 1:5.2, 1:6.4, 1:7.6, or 1:10.

In the present disclosure, in some embodiments, the second mixing is conducted at a temperature of not more than 60° C., and preferably ambient temperature, 40° C., 50° C., or 60° C. In some embodiments, the second mixing is conducted under stirring, and preferably under ultrasound-assisted stirring. In some embodiments, an ultrasound for the ultrasound-assisted stirring is conducted at a frequency of 40 kHz to 60 kHz, and preferably 40 kHz, 50 kHz, or 60 kHz. In some embodiments, the ultrasound is conducted for 15 min to 30 min, and preferably 15 min, 20 min, 25 min, or 30 min.

In the present disclosure, in some embodiments, a mass ratio of the activated clay to the Fe₃O₄ magnetic nanoparticles is in a range of 1:(0.5-0.7), and preferably 1:0.5, 1:0.63, 1:0.67, or 1:0.7.

In the present disclosure, in some embodiments, the Fe₃O₄ magnetic nanoparticles are synthesized through chemical co-precipitation of Fe³⁺ and Fe²⁺ salts.

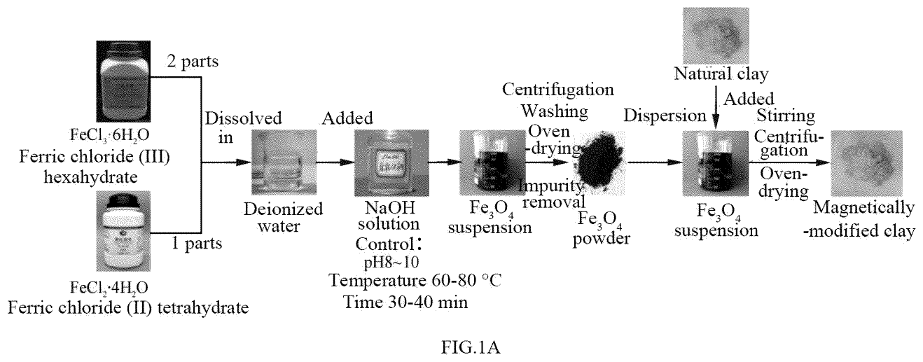

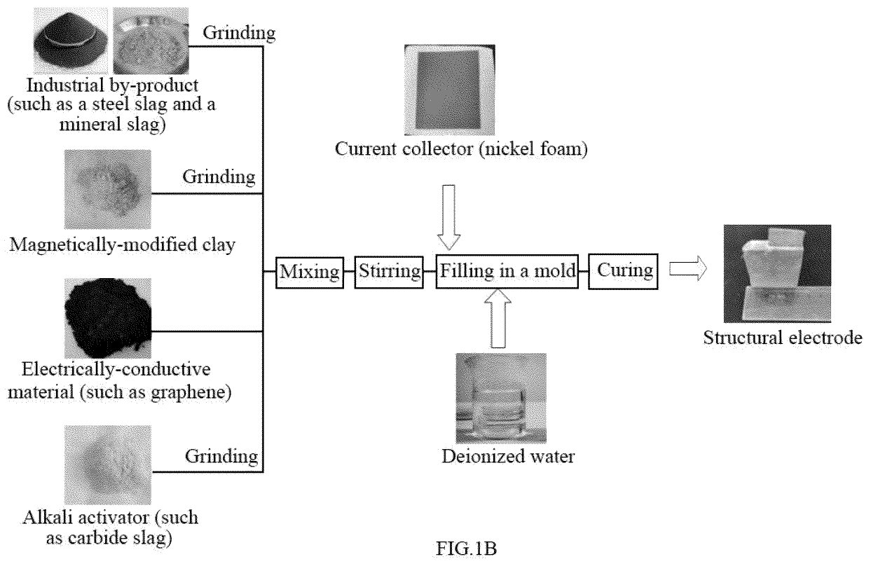

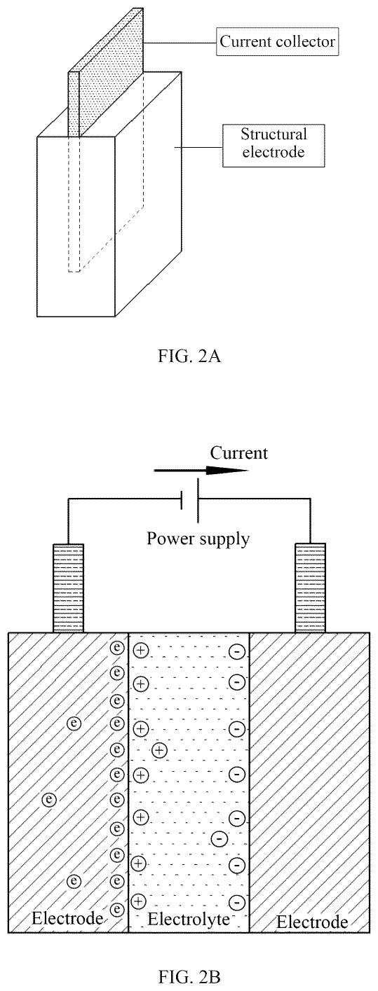

In the present disclosure, in some embodiments, the Fe₃O₄ magnetic nanoparticles is prepared as follows: a ferric salt, a ferrous salt, a pH adjusting agent, and water are mixed (which is denoted as first mixing and leads to a mixed solution), the mixed solution is subjected to co-precipitation reaction to obtain the Fe₃O₄ magnetic nanoparticles (specifically as shown in FIG. 1A).

In the present disclosure, in some embodiments, the pH adjusting agent includes one or two selected from the group consisting of NaOH and NH₄OH. in some embodiments, the water is deionized water.

In the present disclosure, in some embodiments, a molar ratio of the ferric salt to the ferrous salt is in a range of (1.8-1):(2.2-1), and preferably 2:1. In some embodiments, a concentration of the ferric salt in the mixed solution is 0.1 M to 1 M, and preferably 0.5 M. In some embodiments, an amount of the pH adjusting agent is determined to make a pH of the mixed solution be 9 to 11.

In the present disclosure, in some embodiments, the first mixing is conducted as follows: the ferric salt is dissolved (which is denoted as first dissolving) in water to obtain a ferric salt solution; the ferrous salt is dissolved (which is denoted as second dissolving) in water to obtain a ferrous salt solution; the ferric salt solution and the ferrous salt solution are mixed (which is denoted as mixing A) to obtain an iron salt solution; and then the pH adjusting agent is added dropwise to the iron salt solution under stirring.

In the present disclosure, in some embodiments, when bubbles appear during the first dissolving or the second dissolving, a resulting solution obtained after the first dissolving or the second dissolving is subjected to standing for 5 min to 10 min, and preferably 5 min, 7 min, 9 min, or 10 min. In the present disclosure, bubbles in the ferric salt solution or the ferrous salt solution are removed through the standing.

In the present disclosure, in some embodiments, the first dissolving or the second dissolving is independently conducted at a temperature of 40° C. to 60° C., and preferably 40° C., 45° C., 50° C., 55° C., or 60° C. In the present disclosure, the dissolution of the ferric salt and the ferrous salt is accelerated by heating to obtain homogeneous solutions.

In the present disclosure, in some embodiments, the mixing A is conducted under stirring. In some embodiments, the stirring is conducted for not more than 3 min, and preferably 1 min, 2 min, or 3 min. In the present disclosure, a time of the stirring is controlled to prevent Fe²⁺ from being oxidized into Fe³⁺ by oxygen in the air.

In the present disclosure, in some embodiments, the dropwise addition under stirring is conducted at ambient temperature. In some embodiments, the dropwise addition is conducted under magnetic stirring. In some embodiments, the magnetic stirring is conducted at a rotational speed of 300 rpm to 600 rpm, and preferably 300 rpm, 400 rpm, 500 rpm, or 600 rpm. In some embodiments, the dropwise addition is conducted at a rate of 0.5 drop/s to 1.0 drop/s, and preferably 0.5 drop/s, 0.7 drop/s, 0.9 drop/s, or 1.0 drop/s. In some embodiments, the dropwise addition is conducted for not more than 30 min, and preferably 10 min, 15 min, 20 min, 25 min, or 30 min.

In the present disclosure, in some embodiments, the co-precipitation reaction is conducted under stirring. In some embodiments, the stirring is conducted at a rotational speed of 400 rpm to 800 rpm, and preferably 400 rpm, 500 rpm, 600 rpm, 700 rpm, or 800 rpm. In some embodiments, the co-precipitation reaction is conducted at ambient temperature. In some embodiments, the co-precipitation reaction is conducted for 30 min to 60 min, and preferably 30 min, 40 min, 50 min, or 60 min.

In the present disclosure, in some embodiments, a system obtained after the co-precipitation reaction is further subjected to solid-liquid separation, purification, and drying in sequence. In some embodiments, the purification is conducted 1 or more times, and preferably 1 time, 2 times, 3 times, or 4 times.

In the present disclosure, in some embodiments, the solid-liquid separation is conducted through centrifugation. In some embodiments, the centrifugation is conducted at a rotational speed of 7,000 rpm to 9,000 rpm, and preferably 7,000 rpm, 8,000 rpm, or 9,000 rpm. In some embodiments, the centrifugation can be conducted for 10 min to 20 min, and preferably 10 min, 15 min, or 20 min. In the present disclosure, through the solid-liquid separation, the Fe₃O₄ magnetic nanoparticles are precipitated to a bottom of a tube, such that the Fe₃O₄ magnetic nanoparticles are separated from a solution.

In the present disclosure, in some embodiments, the purification includes precipitate redispersion and re-solid-liquid separation in sequence. In some embodiments, the precipitate redispersion is conducted as follows: a precipitate and a dispersion solvent are ultrasonically mixed. In some embodiments, the dispersion solvent is deionized water or ethanol. In some embodiments, a volume ratio of the precipitate to the dispersion solvent is in a range of (2-5):1, and preferably 2:1, 3:1, 4:1, or 5:1. In some embodiments, the ultrasonic mixing is conducted for 15 min to 30 min, and preferably 15 min, 20 min, 25 min, 30 min, or 18 min. In the present disclosure, the dispersion of the precipitate is facilitated by an ultrasound.

In the present disclosure, in some embodiments, parameters of the re-solid-liquid separation are the same as the parameters of the solid-liquid separation, and will not be repeated here.

In the present disclosure, in some embodiments, a device for the drying is an oven. In some embodiments, the drying is conducted at a temperature of 40° C. to 60° C., and preferably 40° C., 45° C., 50° C., 55° C., or 60° C., until a mass change within 24 h is less than 0.1%.

In the present disclosure, in some embodiments, the third mixing is conducted at a temperature of not more than 60° C., and preferably ambient temperature, 40° C., 50° C., or 60° C. In some embodiments, the third mixing is conducted at a rotational speed of 400 rpm to 800 rpm, and preferably 400 rpm, 500 rpm, 600 rpm, 700 rpm, or 800 rpm. In some embodiments, the third mixing is conducted for 30 min to 60 min, and preferably 30 min, 40 min, 50 min, or 60 min. In some embodiments, the third mixing is conducted with the assistance of an ultrasound. In some embodiments, the ultrasound is conducted at a frequency of 40 kHz to 60 kHz, and preferably 40 kHz, 50 kHz, or 60 kHz.

In the present disclosure, in some embodiments, a system obtained after the third mixing is further subjected to solid-liquid separation, water-washing, and drying in sequence. In some embodiments, the solid-liquid separation includes centrifugal separation and magnetic separation.

In the present disclosure, in some embodiments, the centrifugal separation is conducted at a rotational speed of 7,000 rpm to 9,000 rpm for 10 min to 20 min. In the present disclosure, through the centrifugal separation, the magnetically-modified soil is precipitated to a bottom of a tube, and then a supernatant is removed to obtain a magnetically-modified soil precipitate.

In the present disclosure, in some embodiments, the magnetic separation is conducted as follows: a magnet is placed at a bottom of a container holding the system such that the magnetically-modified soil is gathered at the bottom of the container, and then a resulting supernatant is poured out.

In the present disclosure, in some embodiments, water adopted for the water-washing is deionized water. In some embodiments, the water-washing is conducted 3 or more times. In some embodiments, a device for the drying is a vacuum dryer. In some embodiments, the drying is conducted at a temperature of 45° C. to 55° C., and preferably 45° C., 50° C., or 55° C. In some embodiments, the drying is conducted for 24 h.

In the present disclosure, in some embodiments, raw materials for the magnetically-modified soil further include a dispersing agent. In some embodiments, the dispersing agent includes one or more selected from the group consisting of polyvinyl alcohol (PVA), sodium dodecyl sulfate (SDS), and cetyltrimethylammonium bromide (CTAB). In some embodiments, a mass ratio of the dispersing agent to the Fe₃O₄ magnetic nanoparticles is in a range of (3-1):1, and preferably 1:1. In the present disclosure, the dispersing agent is added to prevent the aggregation of the Fe₃O₄ magnetic nanoparticles. In the present disclosure, the Fe₃O₄ magnetic nanoparticles are introduced into nanopores of the clay to prepare the magnetically-modified soil.

In the present disclosure, in some embodiments, a mass ratio of the industrial by-product to the magnetically-modified soil is in a range of (30-80):(20-50), and preferably 30:20, 40:50, 80:20, 70:30, 60:40, 50:30, 50:40, or 50:50.

In the present disclosure, in some embodiments, the electrically-conductive material includes one or more selected from the group consisting of graphene, carbon black, and a carbon nanotube. In some embodiments, a particle size of the electrically-conductive material is 9 μm to 20 μm, and preferably 9 μm, 11 μm, 13 μm, 15 μm, 17 μm, or 20 μm.

In the present disclosure, in some embodiments, a mass ratio of the industrial by-product to the electrically-conductive material is in a range of (30-80):(0.01-5.00), and preferably 30:0.01, 30:0.1, 30:1, 30:3, 30:5, 50:0.1, 60:1, 70:3, 40:4, or 80:0.01.

In the present disclosure, in some embodiments, the alkali activator includes one or more selected from the group consisting of a water-soluble alkali activator and a non-water-soluble alkali activator. In some embodiments, the water-soluble alkali activator includes one or more selected from the group consisting of an industrial alkali, sodium silicate, and potassium carbonate. In some embodiments, the sodium silicate is a sodium silicate solution. In some embodiments, the non-water-soluble alkali activator includes one or more selected from the group consisting of quicklime, a carbide slag, a limestone waste residue, and an alkali residue. In some embodiments, a modulus of the water-soluble alkali activator is designed according to a strength of the industrial by-product, preferably 2.3, 2.4, or 3.3, and more preferably 3.3. In some embodiments, the water-soluble alkali activator has a Baume scale of 30° Bé to 50° Bé. In the present disclosure, by using the alkali activator described above, the loss of a function of the dispersing agent in an alkaline solution caused by an alkali activator such as NaOH and KOH can be avoided, thereby ensuring a dispersion effect of the electrically-conductive material.

In the present disclosure, in some embodiments, a mass ratio of the industrial by-product to the alkali activator is in a range of (30-80):(5-20), and preferably 30:5, 30:10, 30:15, 30:20, 55:5, 40:10, 70:15, 60:20, or 80:5.

In the present disclosure, in some embodiments, when the alkali activator is a water-soluble alkali activator, the industrial by-product, the magnetically-modified soil, the electrically-conductive material, and the alkali activator are mixed as follows: the industrial by-product, the magnetically-modified soil, and the electrically-conductive material are premixed (which is denoted as first premixing) to obtain a premix; the water-soluble alkali activator and water are premixed (which is denoted as second premixing) to obtain a water-soluble alkali activator solution; and then the premix is mixed with the water-soluble alkali activator solution (which is denoted as fourth mixing).

In the present disclosure, in some embodiments, a device for the first premixing is a planetary ball mill. In some embodiments, the first premixing is conducted under stirring. In some embodiments, the stirring is conducted at a rotational speed of 100 rpm to 200 rpm, and preferably 100 rpm, 140 rpm, 170 rpm, or 200 rpm. In some embodiments, the first premixing is conducted for 10 s to 30 s, and preferably 10 s, 15 s, 20 s, 25 s, or 30 s.

In the present disclosure, in some embodiments, the water is deionized water. In some embodiments, a ratio of a mass of the water to a total mass of the industrial by-product, the magnetically-modified soil, and the alkali activator is in a range of (0.50-0.65):1, and preferably 0.50:1, 0.55:1, 0.60:1, or 0.65:1.

In the present disclosure, in some embodiments, the second premixing is conducted under stirring.

In the present disclosure, in some embodiments, the fourth mixing is conducted under stirring. In some embodiments, the stirring is conducted at a rotational speed of 600 rpm to 800 rpm, and preferably 600 rpm, 650 rpm, 700 rpm, 750 rpm, or 800 rpm. In some embodiments, the fourth mixing is conducted for 3 min to 5 min, and preferably 3 min, 4 min, or 5 min.

In the present disclosure, in some embodiments, when the alkali activator is a non-water-soluble alkali activator, the industrial by-product, the magnetically-modified soil, the electrically-conductive material, and the alkali activator are mixed as follows: the alkali activator is premixed (which is denoted as third premixing) with the industrial by-product, the magnetically-modified soil, and the electrically-conductive material to obtain a premix, and then the premix is mixed (which is denoted as fifth mixing) with water.

In the present disclosure, in some embodiments, a device for the third premixing is a planetary ball mill. In some embodiments, the third premixing is conducted under stirring. In some embodiments, the stirring is conducted at a rotational speed of 100 rpm to 200 rpm, and preferably 100 rpm, 140 rpm, 170 rpm, or 200 rpm. In some embodiments, the third premixing is conducted for 10 s to 30 s, and preferably 10 s, 15 s, 20 s, 25 s, or 30 s.

In the present disclosure, in some embodiments, the water is deionized water. In some embodiments, a ratio of a mass of the water to a total mass of the industrial by-product, the magnetically-modified soil, and the alkali activator is in a range of (0.50-0.65):1, and preferably 0.50:1, 0.55:1, 0.60:1, or 0.65:1.

In the present disclosure, in some embodiments, the fifth mixing is conducted under stirring. In some embodiments, the stirring is conducted at a rotational speed of 600 rpm to 800 rpm, and preferably 600 rpm, 650 rpm, 700 rpm, 750 rpm, or 800 rpm. In some embodiments, the fifth mixing is conducted for 3 min to 5 min, and preferably 3 min, 4 min, or 5 min.

In the present disclosure, in some embodiments, raw materials for the mixed slurry further include a superplasticizer. In some embodiments, the superplasticizer is one or more selected from the group consisting of a polycarboxylate superplasticizer (PCE) and a naphthalene superplasticizer (NS). In the present disclosure, according to industrial by-products of different sources, the superplasticizer is selectively added to further optimize the fluidity of the slurry and facilitate the injection molding.

In the present disclosure, after the mixed slurry is obtained, the mixed slurry is compacted and cured in sequence in an external magnetic field to obtain the energy-storage carrying material.

In the present disclosure, in some embodiments, the external magnetic field is provided by a magnet. In some embodiments, a magnetic field intensity of the external magnetic field is 0.01 T to 0.5 T, and preferably 0.01 T, 0.05 T, 0.1 T, 0.3 T, or 0.5 T. In some embodiments, a size of the magnet is not smaller than a size of a bottom surface of a mold. In the present disclosure, the use of the external magnetic field with the above intensity can ensure that the magnetically-modified soil is arranged directionally under an action of the magnetic field, and at the same time, the agglomeration of particles can be reduced, because the magnetic interaction is weak.

In the present disclosure, in some embodiments, a device for the compacting is a shaking table. In some embodiments, the compacting is conducted for 3 min to 5 min, and preferably 3 min, 4 min, or 5 min.

In the present disclosure, in some embodiments, the curing includes a mould curing and a demound curing in sequence. In some embodiments, the mould curing is conducted at a temperature of 18° C. to 22° C. and a humidity of 95% to 98% for 24 h to 48 h (the counting of the curing time starts when vibration is completed).

In the present disclosure, in some embodiments, the demound curing is conducted by soaking in a soaking solution for curing. In some embodiments, a concentration of the soaking solution is 1 M to 6 M, and preferably 1 M, 3 M, 5 M, or 6 M. In some embodiments, the soaking solution includes one or more selected from the group consisting of a NaCl solution, a KCl solution, a Na₂SO₄ solution, a K₂SO₄ solution, a NaOH solution, and a KOH solution. In some embodiments, the demound curing is conducted at ambient temperature. In the present disclosure, the soaking for curing is conducted to make the material have superior capacitance performance.

The present disclosure also provides a structural electrode, including an electrode body and a current collector partially embedded in the electrode body. The electrode body is the energy-storage carrying material described above or the energy-storage carrying material prepared by the method described above.

The structural electrode of the present disclosure includes an electrode body. In some embodiments, the electrode body has a length-to-height ratio of 1:(1-5), and preferably 1:1, 1:2, 1:3, 1:4, or 1:5. In some embodiments, the electrode body has a length-to-width ratio of 1:(0.075-1), and preferably 1:0.075, 1:0.1, 1:0.4, 1:0.7, or 1:1. The electrode body is the energy-storage carrying material described above or the energy-storage carrying material prepared by the preparation method described above.

The structural electrode of the present disclosure includes a current collector. In some embodiments, the current collector is selected from the group consisting of a metal foam, an electrically-conductive fiber, a carbon cloth, a carbon paper, and a stainless steel. In some embodiments, the metal foam is a nickel foam. In some embodiments, a size of the current collector is smaller than a size of the electrode body. In some embodiments, a length and a width of the current collector independently are 75% to 90% of a length and a width of the electrode body, respectively, and preferably 75%, 80%, 85%, or 90%. In the present disclosure, since the size of the current collector is smaller than the size of the electrode body, the fracture of the structural electrode can be avoided.

In the present disclosure, in some embodiments, a connecting part of the electrode body at two sides of the current collector has the same length as the electrode body. In some embodiments, a width of the connecting part of the electrode body at two sides of the current collector is 0.3 cm to 0.7 cm, and preferably 0.3 cm, 0.4 cm, 0.5 cm, 0.6 cm, or 0.7 cm.

The structural electrode provided by the present disclosure has a strength of not less than 10 MPa after curing for 7 days.

The present disclosure also provides a method for preparing the structural electrode described above, including the following steps:
mixing the industrial by-product, the magnetically-modified soil, the electrically-conductive material, and an alkali activator to obtain a mixed slurry; and
injecting the mixed slurry into a mold, placing the current collector in the mixed slurry while the mixed slurry is still in a flowing state, and placing the mold in an external magnetic field and conducting compaction and curing in sequence to obtain the structural electrode (specifically as shown in FIG. 1B).

In the present disclosure, the industrial by-product, the magnetically-modified soil, the electrically-conductive material, and an alkali activator are mixed to obtain a mixed slurry. In the present disclosure, in some embodiments, a method for preparing the mixed slurry is the same as the above solution, and will not be repeated here.

In the present disclosure, after the mixed slurry is obtained, the mixed slurry is injected into a mold, the current collector is placed in the mixed slurry while the mixed slurry is still in a flowing state, and then the mold is placed in an external magnetic field, and subjected to compaction and curing in sequence to obtain the structural electrode. In the present disclosure, there is no particular limitation on a specific type of the mold, as long as a size of the mold can match the size of the electrode body to be prepared above. In some embodiments of the present disclosure, the mold is selected from the group consisting of an iron mold, a polyethylene mold, and a silicone mold.

In the present disclosure, in some embodiments, a distance between an edge of the current collector and an edge of the mold is 0.3 cm to 0.7 cm, and preferably 0.3 cm, 0.4 cm, 0.5 cm, 0.6 cm, or 0.7 cm.

In the present disclosure, in some embodiments, the external magnetic field is provided by a magnet. In some embodiments, a magnetic field intensity of the external magnetic field is in a range of 0.01 T to 0.5 T, and preferably 0.01 T, 0.05 T, 0.1 T, 0.3 T, or 0.5 T. In some embodiments, a size of the magnet is not smaller than a size of a bottom surface of the mold.

In the present disclosure, in some embodiments, a device for the compacting is a shaking table. In some embodiments, the compacting is conducted for 3 min to 5 min, and preferably 3 min, 4 min, or 5 min.

In the present disclosure, in some embodiments, the curing includes a mound curing and a demound curing in sequence. In some embodiments, the mound curing is conducted at a temperature of 18° C. to 22° C. and a humidity of 95% to 98% for 24 h to 48 h (the counting of the curing time starts when vibration is completed).

In the present disclosure, in some embodiments, the demound curing is conducted by soaking in a soaking solution for curing. In some embodiments, a concentration of the soaking solution is 1 M to 6 M, and preferably 1 M, 3 M, 5 M, or 6 M. In some embodiments, the soaking solution includes one or more selected from the group consisting of a NaCl solution, a KCl solution, a Na₂SO₄ solution, a K₂SO₄ solution, a NaOH solution, and a KOH solution. In some embodiments, the demound curing is conducted at ambient temperature. In the present disclosure, the soaking for curing is conducted to make the material have superior capacitance performance.

The present disclosure also provides use of the structural electrode described above or a structural electrode prepared by the method described above in a field of energy development and utilization.

The structural electrode provided by the present disclosure can be used in the field of energy development and utilization, and specifically can be used for energy utilization in the construction field or energy utilization in the civil engineering field, such as foundations or partition walls for buildings. Therefore, the structural electrode can support the energy self-sufficiency of buildings, can promote the development of green energy buildings and energy self-sufficient buildings, and has a high market promotion value.

In order to further illustrate the present disclosure, the solutions of the present disclosure are described in detail below in conjunction with the accompanying drawings and examples, but these examples should not be understood as limiting the scope of the present disclosure.

### Example 1

In this example, a method for preparing a structural electrode with both an energy-storage capacity and a high compressive strength was provided. The method adopted a mineral powder, a steel slag, sodium silicate, a magnetically-modified clay, and graphene. The method was conducted as follows:
(1) A mineral slag and a steel slag of 64 g in total each were taken, oven-dried at 105° C. for 24 h, and then ground with a planetary ball mill for 10 min to obtain a mineral slag micropowder and a steel slag micropowder. A muddy clay was oven-dried at 105° C. for 24 h and then ground with a planetary ball mill at a rotational speed of 16 rpm for 15 min to obtain a clay powder, and 30 g of the clay powder was taken. 0.1 g of graphene was taken.
(2) 9.33 g of FeCl₃·6H₂O and 3.43 g of FeCl₂·4H₂O were weighed, such that a molar ratio of Fe³⁺ to Fe²⁺ was 2:1. The FeCl₃·6H₂O and FeCl₂·4H₂O were simultaneously dissolved in 103.62 g of deionized water to prepare a 0.5 M iron salt solution.
(3) The iron salt solution prepared in step (2) was slowly added dropwise to a beaker with a 10% NaOH solution under stirring to obtain a mixed solution with a pH controlled at 9±0.3. The mixed solution was stirred and heated to 70° C., and a co-precipitation reaction was conducted continuously for 30 min to obtain a reaction solution. Then, Fe₃O₄ magnetic nanoparticles were separated from the reaction solution with a centrifuge, and repeatedly washed with deionized water until a pH of a resulting washing solution was 7.
(4) An activated clay was added to deionized water with a clay-water ratio of 1:5 to obtain a clay suspension.
(5) With a mass ratio of the clay to the Fe₃O₄ magnetic nanoparticles being 1:0.5, the Fe₃O₄ magnetic nanoparticles were added to the clay suspension obtained in step (4) (a mass ratio of the Fe₃O₄ magnetic nanoparticles to the deionized water was 1:10), and stirred for 30 min to obtain a mixture. The mixture was filtered to obtain a filter cake on a filter paper. The filter cake was dried in a drying oven at 60° C. to a constant weight, and then ground into a fine powder to obtain a magnetically-modified clay.
(6) The mineral slag micropowder, the steel slag micropowder, the magnetically-modified clay, and the graphene were mixed in a planetary ball mill for 30 s, and then transferred into a stirring pot.
(7) According to a water-to-cement ratio of 0.6, deionized water was weighed. The deionized water and a sodium silicate solution were simultaneously poured into the stirring pot, and stirred with a stirrer for 3 min to obtain a homogeneous mixed slurry.
(8) The homogeneous mixed slurry obtained in step (7) was injected into a 4 cm×4 cm×0.5 cm (side length×side length×thickness) mold. A nickel foam was cut to 3.5 cm×3.5 cm×0.1 cm (side length×side length×thickness) and then immersed in the mixed slurry with excellent fluidity.
(9) The mold was placed on a shaking table. A magnetic field was applied at two ends of the mold for interference. The shaking table was turned on, and shaked for 3 min. Then, the mold and the magnetic field together were transferred into a curing chamber. When the mixed slurry was hardened, demolding was conducted. Then curing was further conducted until day 28 to obtain the structural electrode.

### Example 2

In this example, a method for preparing a structural electrode with both an energy-storage capacity and a high compressive strength was provided. The method adopted a mineral powder, a steel slag, sodium silicate, a magnetically-modified clay, and graphene. The method was conducted as follows:
(1) A mineral slag and a steel slag of 64 g in total each were taken, oven-dried at 105° C. for 24 h, and then ground with a planetary ball mill for 10 min to obtain a mineral slag micropowder and a steel slag micropowder. A muddy clay was oven-dried at 105° C. for 24 h and then ground with a planetary ball mill at a rotational speed of 16 rpm for 15 min to obtain a clay powder, and 30 g of the clay powder was taken.
(2) 9.33 g of FeCl₃·6H₂O and 3.43 g of FeCl₂·4H₂O were weighed, such that a molar ratio of Fe₃ to Fe₂ was 2:1. The FeCl₃·6H₂O and FeCl₂·4H₂O were simultaneously dissolved in 103.62 g of deionized water to prepare a 0.5 M iron salt solution.
(3) The iron salt solution prepared in step (2) was slowly added dropwise to a beaker with a 10% NaOH solution under stirring to obtain a mixed solution with a pH controlled at 8. The mixed solution was stirred and heated to 80° C., and a co-precipitation reaction was conducted continuously for 30 min to obtain a reaction solution. Then, Fe₃O₄ magnetic nanoparticles were separated from the reaction solution with a centrifuge, and repeatedly washed with deionized water until a pH of a resulting washing solution was 8.
(4) An activated clay was added to deionized water with a clay-water ratio of 1:5 to obtain a clay suspension.
(5) With a mass ratio of the clay to the Fe₃O₄ magnetic nanoparticles being 1:0.5, the Fe₃O₄ magnetic nanoparticles were added to the clay suspension obtained in step (4) (a mass ratio of the Fe₃O₄ magnetic nanoparticles to the deionized water was 1:10), and stirred for 30 min to obtain a mixture. The mixture was filtered to obtain a filter cake on a filter paper. The filter cake was dried in a drying oven at 60° C. to a constant weight, and then ground into a fine powder to obtain a magnetically-modified clay.
(6) The mineral slag micropowder, the steel slag micropowder, and the magnetically-modified clay were mixed in a planetary ball mill for 30 s, and then transferred into a stirring pot.
(7) According to a water-to-cement ratio of 0.6, deionized water was weighed. 0.1 g of graphene was weighed, added to a beaker with the deionized water, and dispersed in an ultrasonic cleaning machine for 2 h to obtain a homogeneous graphene dispersion. The graphene dispersion and a sodium silicate solution were simultaneously poured into the stirring pot, and stirred with a stirrer for 3 min or more until a homogeneous mixed slurry was obtained.
(8) 20 g of the mixed slurry obtained in step (7) was injected into a 4 cm×4 cm×0.5 cm (side length×side length×thickness) mold. A nickel foam was cut to 3.5 cm×3.5 cm×0.1 cm (side length×side length×thickness) and then immersed in the mixed slurry with excellent fluidity.
(9) The mold was placed on a shaking table. A magnetic field was applied at two ends of the mold for interference. The shaking table was turned on, and shaked for 3 min. Then, the mold and the magnetic field together were transferred into a curing chamber. When the mixed slurry was hardened, demolding was conducted. Then curing was further conducted until day 28 to obtain the structural electrode.

### Example 3

In this example, a method for preparing a structural electrode with both an energy-storage capacity and a high compressive strength was provided. The method adopted a mineral powder, a steel slag, sodium silicate, a magnetically-modified clay, and graphene. The method was conducted as follows:
(1) A mineral slag and a steel slag of 64 g in total each were taken, oven-dried at 105° C. for 24 h, and then ground with a planetary ball mill for 10 min to obtain a mineral slag micropowder and a steel slag micropowder. A muddy clay was oven-dried at 105° C. for 24 h and then ground with a planetary ball mill at a rotational speed of 16 rpm for 15 min to obtain a clay powder, and 30 g of the clay powder was taken.
(2) 9.33 g of FeCl₃·6H₂O and 3.43 g of FeCl₂·4H₂O were weighed, such that a molar ratio of Fe³⁺ to Fe²⁺ was 2:1. The FeCl₃·6H₂O and FeCl₂·4H₂O were simultaneously dissolved in 103.62 g of deionized water to prepare a 0.5 M iron salt solution.
(3) The iron salt solution prepared in step (2) was slowly added dropwise to a beaker with a 10% NaOH solution under stirring to obtain a mixed solution with a pH controlled at 9. The mixed solution was stirred and heated to 75° C., and a co-precipitation reaction was conducted continuously for 30 min to obtain a reaction solution. Then, Fe₃O₄ magnetic nanoparticles were separated from the reaction solution with a centrifuge, and repeatedly washed with deionized water until a pH of a resulting washing solution was 7.
(4) An activated clay was added to deionized water with a clay-water ratio of 1:5 to obtain a clay suspension.
(5) With a mass ratio of the clay to the Fe₃O₄ magnetic nanoparticles being 1:0.5, the Fe₃O₄ magnetic nanoparticles were added to the clay suspension obtained in step (4) (a mass ratio of the Fe₃O₄ magnetic nanoparticles to the deionized water was 1:10), and stirred for 30 min to obtain a mixture. The mixture was filtered to obtain a filter cake on a filter paper. The filter cake was dried in a drying oven at 60° C. to a constant weight, and then ground into a fine powder to obtain a magnetically-modified clay.
(6) The mineral slag micropowder, the steel slag micropowder, and the magnetically-modified clay were mixed in a planetary ball mill for 30 s, and then transferred into a stirring pot.
(7) According to a water-to-cement ratio of 0.6, deionized water was weighed. 0.1 g of graphene was weighed, added to a beaker with the deionized water, and dispersed in an ultrasonic cleaning machine for 2 h to obtain a homogeneous graphene dispersion. The graphene dispersion and a sodium silicate solution were simultaneously poured into the stirring pot, and stirred with a stirrer for 3 min to obtain a homogeneous mixed slurry.
(8) 20 g of the mixed slurry obtained in step (7) was injected into a 4 cm×4 cm×0.5 cm (side length×side length×thickness) mold. A nickel foam was cut to 3.5 cm×3.5 cm×0.1 cm (side length×side length×thickness) and then immersed in the homogeneous mixed slurry with excellent fluidity.
(9) The mold was placed on a shaking table. A magnetic field was applied at two ends of the mold for interference. The shaking table was turned on, and shaked for 3 min. Then, the mold and the magnetic field together were transferred into a curing chamber. When the mixed slurry was hardened, demolding was conducted. Then curing was further conducted until day 28 to obtain the structural electrode.

### Comparative Example 1

In this comparative example, a structural electrode was prepared with a mineral powder, a steel slag, sodium silicate, a muddy clay, and graphene through the following steps:
(1) A mineral slag and a steel slag of 64 g in total each were taken, oven-dried at 105° C. for 24 h, and then ground with a planetary ball mill for 10 min to obtain a mineral slag micropowder and a steel slag micropowder. A muddy clay was oven-dried at 105° C. for 24 h, crushed, ground, and sieved through a 200-mesh sieve to obtain an undersize material, and 30 g of the undersize material was taken.
(2) The mineral slag micropowder, the steel slag micropowder, and the muddy clay were mixed in a planetary ball mill for 30 s, and then transferred into a stirring pot.
(3) According to a water-to-cement ratio of 0.6, deionized water was weighed. 0.1 g of graphene was weighed, added to a beaker with the deionized water, and dispersed in an ultrasonic cleaning machine for 2 h to obtain a homogeneous graphene dispersion. The graphene dispersion and a sodium silicate solution were simultaneously poured into the stirring pot, and stirred with a stirrer for 3 min to obtain a homogeneous mixed slurry.
(4) 20 g of the mixed slurry obtained in step (3) was injected into a mold. A nickel foam was cut to 3.5 cm×3.5 cm×0.1 cm (side length×side length×thickness) and then immersed into the homogeneous mixed slurry with excellent fluidity.
(5) The mold was placed on a shaking table and shaked for 3 min. Then, the mold was transferred into a curing chamber. When the mixed slurry was hardened, demolding was conducted. Then curing was further conducted until day 28 to obtain the structural electrode.

### Comparative Example 2

In this comparative example, a structural electrode was prepared with a mineral powder, a steel slag, sodium silicate, and graphene through the following steps:
(1) A mineral slag and a steel slag of 64 g in total each were taken, oven-dried at 105° C. for 24 h, and then ground with a planetary ball mill for 10 min to obtain a mineral slag micropowder and a steel slag micropowder.
(2) The mineral slag micropowder and the steel slag micropowder were mixed in a planetary ball mill for 30 s, and then transferred into a stirring pot.
(3) According to a water-to-cement ratio of 0.6, deionized water was weighed. 0.1 g of graphene was weighed, added to a beaker with the deionized water, and dispersed in an ultrasonic cleaning machine for 2 h to obtain a homogeneous graphene dispersion. The graphene dispersion and a sodium silicate solution were simultaneously poured into the stirring pot, and stirred with a stirrer for 3 min to obtain a homogeneous mixed slurry.
(4) 20 g of the mixed slurry obtained in step (3) was injected into a 4 cm×4 cm×0.5 cm (side length×side length×thickness) mold. A nickel foam was cut to 3.5 cm×3.5 cm×0.1 cm (side length×side length×thickness) and then immersed in the homogeneous mixed slurry with excellent fluidity.
(5) The mold was placed on a shaking table and shaked for 3 min. Then, the mold was transferred into a curing chamber. When the mixed slurry was hardened, demolding was conducted. Then curing was further conducted until day 28 to obtain the structural electrode.

### Comparative Example 3

In this comparative example, a structural electrode was prepared with a Portland cement (P.O. 42.5), a magnetically-modified clay, and graphene through the following steps:
(1) 64 g of a cement was weighed. A muddy clay was oven-dried at 105° C. for 24 h, crushed, ground, and sieved through a 200-mesh sieve to obtain an undersize material, and 30 g of the undersize material was taken.
(2) With a molar ratio of Fe₃ to Fe₂ being 2:1, 9.33 g of FeCl₃·6H₂O and 3.43 g of FeCl₂·4H₂O were weighed and simultaneously dissolved in 103.62 g of deionized water to prepare a 0.5 M iron salt solution.
(3) The iron salt solution prepared in step (2) was slowly added dropwise to a beaker with a 10% NaOH solution under stirring to obtain a mixed solution with a pH controlled at 9. The mixed solution was stirred and heated to 70° C., and a reaction was conducted continuously for 30 min to obtain a reaction solution. Fe₃O₄ magnetic nanoparticles were separated from the reaction solution with a centrifuge, and repeatedly washed with deionized water until a pH of a resulting washing solution was 8.
(4) An activated clay was added to deionized water with a clay-water ratio of 30:5 to obtain a clay suspension.
(5) With a mass ratio of the clay to the Fe₃O₄ magnetic nanoparticles being 1:0.5, the Fe₃O₄ magnetic nanoparticles were added to the clay suspension obtained in step (4) (a mass ratio of the Fe₃O₄ magnetic nanoparticles to the deionized water was 1:10), and stirred for 30 min to obtain a mixture. The mixture was filtered to obtain a filter cake on a filter paper. The filter cake was dried in a drying oven at 60° C. to a constant weight, and then ground into a fine powder to obtain a magnetically-modified clay.
(6) The cement and the magnetically-modified clay were mixed in a planetary ball mill for 30 s, and then transferred into a stirring pot.
(7) According to a water-to-cement ratio of 0.6, deionized water was weighed. 0.1 g of graphene was weighed, added to a beaker with the deionized water, and dispersed in an ultrasonic cleaning machine for 2 h to obtain a homogeneous graphene dispersion. The graphene dispersion and a sodium silicate solution were simultaneously poured into the stirring pot, and stirred with a stirrer for 3 min to obtain a homogeneous mixed slurry.
(8) 20 g of the mixed slurry obtained in step (7) was injected into a 4 cm×4 cm×0.5 cm (side length×side length×thickness) mold. A nickel foam was cut to 3.5 cm×3.5 cm×0.1 cm (side length×side length×thickness) and then immersed into the homogeneous mixed slurry with excellent fluidity.
(9) The mold was placed on a shaking table. A magnetic field was applied at two ends of the mold (a direction of the magnetic field was parallel to a surface of the nickel foam). The shaking table was turned on, and shaked for 3 min. Then, the mold and the magnetic field together were transferred into a curing chamber. When the mixed slurry was hardened, demolding was conducted. Then curing was further conducted until day 28 to obtain the structural electrode.

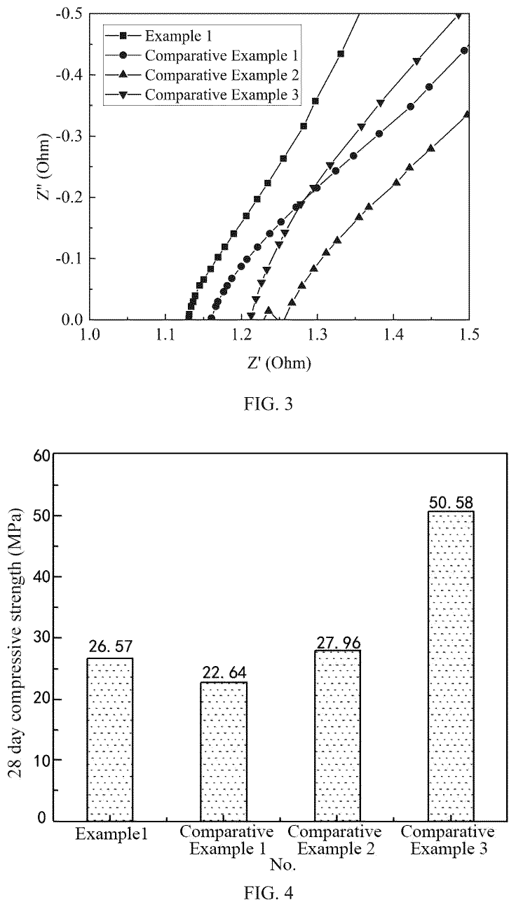

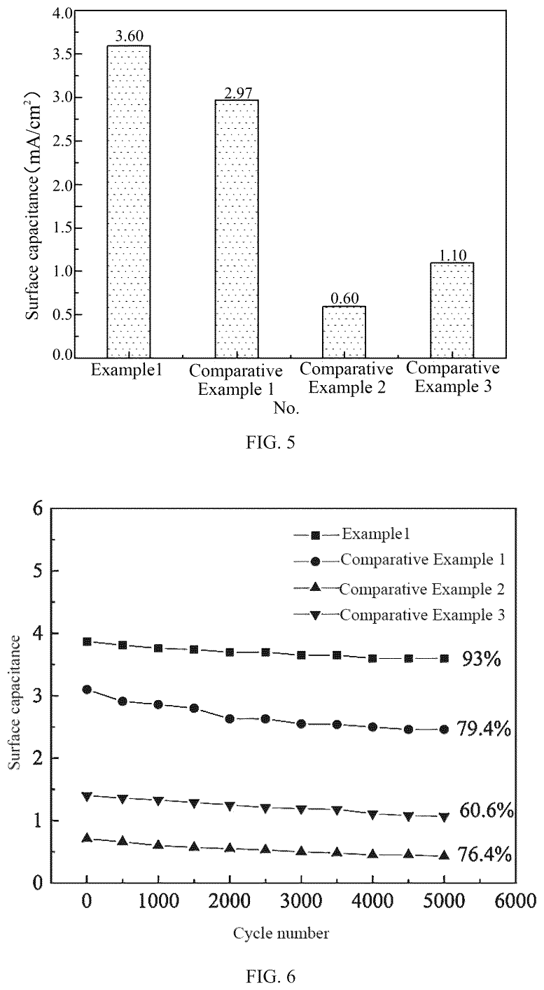

The structural electrodes in Example 1 and Comparative Examples 1 to 3 each were subjected to EIS and compressive strength (CS) tests with a three-electrode system, and test results are shown in FIG. 3 and FIG. 4. Surface capacitances of the structural electrodes in Example 1 and Comparative Examples 1 to 3 were determined, and test results are shown in FIG. 5. As shown in FIG. 3 to FIG. 5, an ohmic internal resistance of the structural electrode prepared with an industrial by-product is 7.2% lower than an ohmic internal resistance of the cement sample (Comparative Example 3), and a surface capacitance of the structural electrode prepared with an industrial by-product is 327% of a surface capacitance of the cement sample (Comparative Example 3), indicating that the structural electrode prepared with an industrial by-product has a better effect than the cement. The electrode prepared with a magnetically-modified clay has a better effect than the electrode prepared with an unmodified clay, indicating that the structural electrode prepared with the industrial by-product and the magnetically-modified soil has the potential to be used in construction.

The structural electrodes in Example 1 and Comparative Examples 1 to 3 each were subjected to a cycling retention rate test, and test results are shown in FIG. 6. It can be seen from FIG. 6 that the structural electrode prepared by the present disclosure has a cycling retention rate of not less than 93% under 5,000 cycles.

It can be known from the above examples that the structural electrode provided by the present disclosure has both a carrying capacity and an energy-storage capacity, a high cycling retention rate, a high compressive strength, excellent stability, and superior compatibility with buildings.

Although the present disclosure is described in detail through the above examples, the above examples are merely some rather than all of the examples of the present disclosure. Other examples can be obtained based on the above examples without creative efforts, and all of these examples shall fall within the scope of the present disclosure.

1. An energy-storage carrying material, comprising a matrix and an electrically-conductive network structure distributed inside the matrix,
wherein the matrix is a hydration product of an industrial by-product; and the electrically-conductive network structure comprises an electrically-conductive material and a magnetically-modified soil.

2. The energy-storage carrying material of claim 1, wherein a mass ratio of the matrix to the electrically-conductive network structure is in a range of 35-100:0.01-5; and
a mass ratio of the electrically-conductive material to the magnetically-modified soil is in a range of 0.01-5:20-50.

3. A method for preparing the energy-storage carrying material of claim 1, comprising the following steps:
mixing the industrial by-product, the magnetically-modified soil, the electrically-conductive material, and an alkali activator to obtain a mixed slurry, wherein the industrial by-product has a pozzolanic activity and is able to undergo a pozzolanic reaction in an environment with a pH of not less than 10; and
subjecting the mixed slurry to compacting and curing in sequence in an external magnetic field to obtain the energy-storage carrying material.

4. The method of claim 3, wherein a mass ratio of the matrix to the electrically-conductive network structure is in a range of 35-100:0.01-5; and
a mass ratio of the electrically-conductive material to the magnetically-modified soil is in a range of 0.01-5:20-50.

5. The method of claim 3, wherein the magnetically-modified soil is a magnetically-modified clay; and
the magnetically-modified clay is prepared by the following steps:
mixing an activated clay with water to obtain a clay suspension, adding Fe₃O₄ magnetic nanoparticles to the clay suspension, and stirring and mixing, such that clay particles in the clay suspension adsorb the Fe₃O₄ magnetic nanoparticles, wherein the Fe₃O₄ magnetic nanoparticles are synthesized through chemical co-precipitation of Fe³⁺ and Fe²⁺ salts.

6. A structural electrode, comprising an electrode body and a current collector partially embedded in the electrode body,
wherein the electrode body is the energy-storage carrying material of claim 1.

7. The structural electrode of claim 6, wherein a connecting part of the electrode body at two sides of the current collector has a same length as the electrode body, and a width of 0.3 cm to 0.7 cm.

8. The structural electrode of claim 6, wherein a mass ratio of the matrix to the electrically-conductive network structure is in a range of 35-100:0.01-5; and
a mass ratio of the electrically-conductive material to the magnetically-modified soil is in a range of 0.01-5:20-50.

9. A method for preparing the structural electrode of claim 6, comprising the following steps:
mixing the industrial by-product, the magnetically-modified soil, the electrically-conductive material, and an alkali activator to obtain a mixed slurry; and
injecting the mixed slurry into a mold, placing the current collector in the mixed slurry while the mixed slurry is still in a flowing state, and placing the mold in an external magnetic field and conducting compaction and curing in sequence to obtain the structural electrode.

10. The method of claim 9, wherein the curing comprises a mould curing and a demound curing in sequence; and
the mould curing is conducted at a temperature of 18° C. to 22° C. and a humidity of 95% to 98% for 24 h to 48 h.

11. The method of claim 10, wherein the demound curing is conducted by soaking in a soaking solution for curing;
a concentration of the soaking solution is 1 M to 6 M; and the demound curing is conducted at ambient temperature; and
the soaking solution comprises one or more selected from the group consisting of a NaCl solution, a KCl solution, a Na₂SO₄ solution, a K₂SO₄ solution, a NaOH solution, and a KOH solution.

12. The method of claim 9, wherein a connecting part of the electrode body at two sides of the current collector has a same length as the electrode body, and a width of 0.3 cm to 0.7 cm.

13. The method of claim 9, wherein a mass ratio of the matrix to the electrically-conductive network structure is in a range of 35-100:0.01-5; and
a mass ratio of the electrically-conductive material to the magnetically-modified soil is in a range of 0.01-5:20-50.
